(19) United States
(12) Patent Application Publication
(10) Pub. No.: US 2012/0014839 A1
(43) Pub. Date: Jan. 19, 2012

(54) ACTIVE CO NEUTRALIZING DEVICE

(76) Inventor: Tu-Cheng PEN, Taichung City (TW)

(21) Appl. No.: 12/836,887

(22) Filed: Jul. 15, 2010

(51) Int. Cl. G05D 7/06

(52) U.S. Cl. 422/111

(57) ABSTRACT

An active CO neutralizing device includes a CO sensing unit, a control unit, an alarm unit and an ozone releasing unit and serves to detect a concentration of carbon monoxide in the air and to automatically release ozone to react with carbon monoxide when the detected concentration of carbon monoxide is in excess of a preset threshold so as to neutralize and thereby dilute carbon monoxide in order to minimize the risk of carbon monoxide poisoning and allow more time for rescue.

### BACKGROUND OF THE INVENTION

1. Technical Field

The present invention relates to devices for detecting and neutralizing carbon monoxide, and more particularly to an active CO neutralizing device which serves to detect a concentration of carbon monoxide in ambient air and automatically release ozone when the concentration of carbon monoxide is in excess of a preset threshold.

2. Description of Related Art

Our living environment is rife with sources of carbon monoxide (CO), such as gas emission from vehicles, waste gas from factory chimneys and burned coal or fuel gas. Inhalation of excessive carbon monoxide can significantly retard oxygen transmission over blood flow in human body. Since carbon monoxide is more bondable to hemoglobin cells than oxygen is, carbon monoxide occupies hemoglobin cells and hinders hemoglobin cells from carrying oxygen. As a result, tissue hypoxia and symptoms mediated by carbon monoxide take place in vivo. As such, severity of carbon monoxide positioning is subject to both CO concentration and exposing time. Long-term exposure to low-level carbon monoxide may bring humans about encephalalgia, emesis and other minor syndromes. On the other hand, high-level CO concentration can cause coma in several seconds and cause even irrecoverable brain damage or death. The most dangerous factor is that carbon monoxide is a colorless, odorless and non-stimulated gas, which can not be detected merely by human senses without assistance of detecting equipment.

At present, carbon monoxide detectors are typically provided with solid-state semiconductor sensors, optical sensors, electrochemical sensors or other sensing mechanisms. However, all the existing CO detectors are functionally limited to passive detection followed by a warning means such as an alarm sound, a warning light or vibratility when high-level carbon monoxide is detected. Although the warning means helps to warn people in danger with the risk, exposure to high-level carbon monoxide can make people unconscious in just a few seconds, as mentioned above. Therefore, in the course where the conventional CO detectors confirms the high concentration of carbon monoxide and subsequently gives out warnings, carbon monoxide is likely to keep accumulating in the environment and worse threaten human life. As a result, people can even die due to over inhalation before the alarm ends.

### SUMMARY OF THE INVENTION

With the attempt to remedy the shortcomings of the existing passive CO detectors, the present invention herein provides an active CO neutralizing device, which comprises:

a CO sensing unit for detecting a concentration of ambient carbon monoxide and comparing the concentration with a preset threshold so that when the concentration is greater than the threshold, the CO sensing unit generates a warning signal;

a control unit electrically connected to the CO sensing unit and configured to receive the warning signal and generate a trigger signal and a release signal in response to the warning signal;

an alarm unit configured to receive the trigger signal and give out acoustic and visual warning messages; and

an ozone releasing unit configured to receive the release signal and release ozone in response to the release signal,

whereby the active CO neutralizing device is enabled to detect the ambient carbon monoxide and automatically release ozone for neutralizing the carbon monoxide so as to prevent carbon monoxide poisoning.

The primary objective of the present invention is to provide the above-disclosed active CO neutralizing device, wherein the ozone releasing unit is configured to generate and release ozone for neutralizing ambient carbon monoxide basing on the following equation: CO(carbon monoxide)+O₃(ozone)->CO₂(carbon dioxide)+O₂ (oxygen). As a result of combination between carbon monoxide and ozone, carbon dioxide and oxygen as odorless, poison-free and stable gaseous substances are generated. Since carbon dioxide is less binding to hemoglobin cells as oxygen is, combination between oxygen and hemoglobin cells can remain good. Meantime, the raised level of ambient oxygen can further ameliorate or remedy carbon monoxide poisoning caused by previous over inhalation of CO, so the people poisoned can stay conscious to call for help and more time for rescue can be allowed.

Another objective of the present invention is to provide the above-disclosed active CO neutralizing device, wherein active neutralization of carbon monoxide is achieved by the ozone releasing unit that releases ozone immediately, and ambient oxygen is increased through the neutralizing reaction between ozone and carbon monoxide.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is a block diagram showing an active CO neutralizing device according to the present invention; and

FIGS. 2 and 3 diagrammatically illustrate operation of the active CO neutralizing device of the present invention.

### DETAILED DESCRIPTION OF THE INVENTION

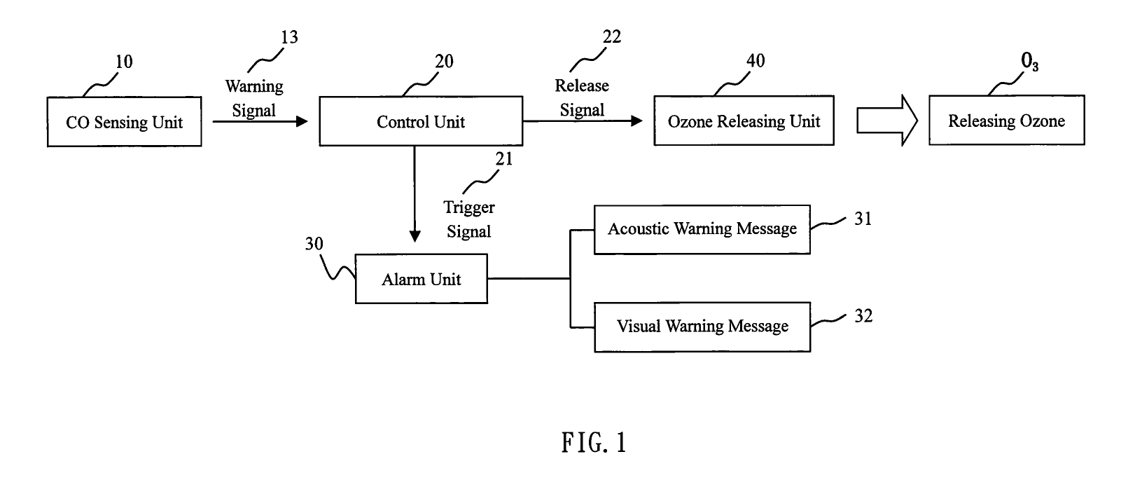

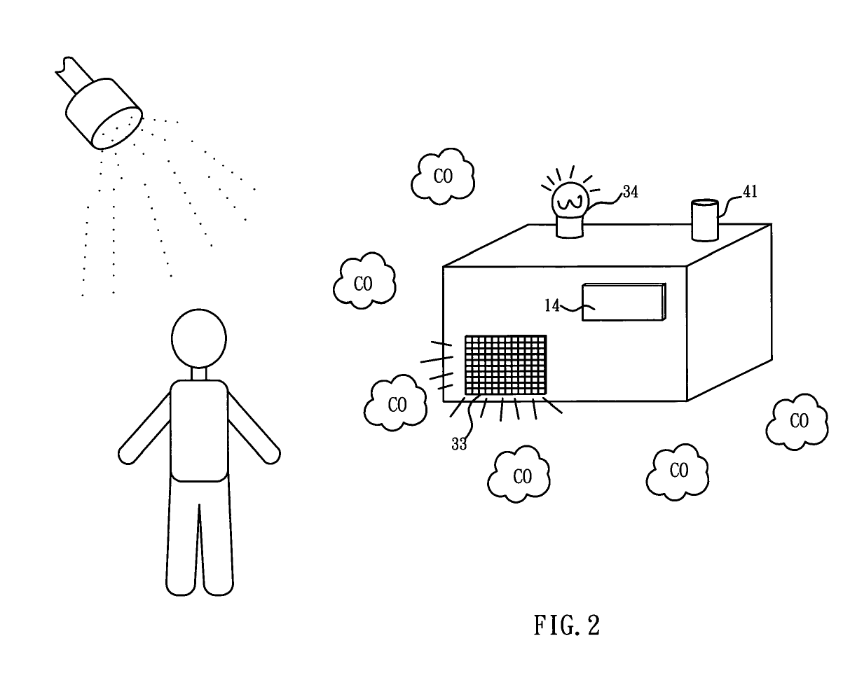

Referring to FIG. 1 and FIG. 2, an active CO neutralizing device of the present invention comprises a CO sensing unit 10, a control unit 20, an alarm unit 30, and an ozone releasing unit 40.

The CO sensing unit 10 is configured to detect a concentration of ambient carbon monoxide and compare the concentration with a preset threshold, so that when the concentration is greater than the threshold, the CO sensing unit 10 generates a warning signal 13. The CO sensing unit 10 further includes a display sub-unit 14 for displaying the currently detected concentration of carbon monoxide. In addition, the CO sensing unit 10 has a microcomputer device or a mechatronically automatic control device, for detecting the concentration of ambient carbon monoxide. The concentration is compared with the preset threshold so as to form a basis for outputting the warning signal 13.

The control unit 20 is electrically connected to the CO sensing unit 10 for receiving the warning signal 13. The control unit 20, after receiving the warning signal 13, outputs a trigger signal 21 and a release signal 22.

The alarm unit 30 is configured to receive the trigger signal 21 and output acoustic and visual warning messages 31, 32. The alarm unit 30 may be a buzzer 33. When the CO sensing unit 10 detects and confirms that the concentration of ambient carbon monoxide is greater than the threshold, the alarm unit 30 drives the buzzer 33 to give out the acoustic warning messages 31. In addition, the alarm unit 30 may be a warning light 34, so that when the CO sensing unit 10 detects and confirms that the concentration of ambient carbon monoxide is greater than the threshold, the alarm unit 30 directs the warning light 34 to give out the visual warning messages 32.

The ozone releasing unit 40 receives the release signal 22 and releases ozone. The ozone releasing unit 40 includes an ozone generator 41 that generates ozone. For example, the ozone generator 41 may be a ceramic ozone generator that, after started, generates ozone and releases ozone into ambient air. The released ozone molecules then react with carbon monoxide molecules to produce carbon dioxide and oxygen.

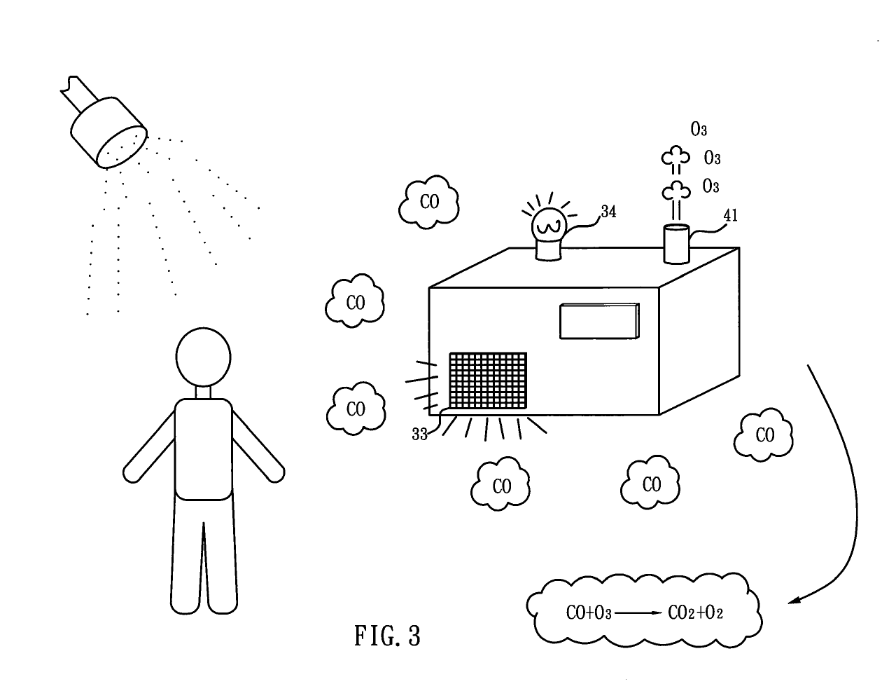

FIG. 2 and FIG. 3 depict a practical application of the present invention. Therein, a bathroom, known as the place where carbon monoxide poisoning most frequently happens, is taken as an example. Referring to FIG. 2, gas leak takes place or excessive carbon monoxide exists in the bathroom. At this time, since carbon monoxide is a colorless, odorless and non-stimulated gas, a person in the atmosphere can not easily detect the danger. The CO sensing unit 10 of the present invention uses the microcomputer device or automatic control device to detect CO and implements the display sub-unit 14 to display the current concentration of ambient carbon monoxide. When it is determined that the concentration of ambient carbon monoxide is higher than the preset threshold, the CO sensing unit 10 outputs a warning signal 13 to the control unit 20. The control unit 20 receives the warning signal 13 and then outputs a trigger signal 21 to the alarm unit 30 so that the alarm unit 30 operates accordingly to give out the acoustic warning message 31 and the visual warning message 32 to warn the person in site that the concentration of ambient carbon monoxide is higher than the threshold. The alarm unit 30 uses the buzzer 33 and the warning light 34 to warn the person in danger or to inform other people nearby or in the next room of the abnormal CO concentration, so that the person in danger can ask for help or the people nearby can rescue the person in danger without delay. At the same time, the control unit 20 outputs the release signal 22 to the ozone releasing unit 40 so that the ozone releasing unit 40 receiving the release signal 22 drives the ozone generator 41 to generate and release ozone for neutralizing ambient carbon monoxide.

An equation describing the reaction between ozone molecules and carbon monoxide molecules can be expressed as: CO (carbon monoxide)+O₃ (ozone)->CO₂ (carbon dioxide)+O₂ (oxygen). The products of the foregoing reaction are carbon dioxide and oxygen. By comparison, carbon dioxide is less binding to hemoglobin cells than oxygen is, so it does not hinder oxygen from binding hemoglobin cells. Meantime, the raised level of ambient oxygen can further ameliorate or remedy carbon monoxide poisoning caused by previous over inhalation of CO, so the person poisoned can stay conscious to call for help and have more time to await rescue thereby increasing survival odds.

Thereby, the CO sensing unit 10 is effective in monitoring the concentration of ambient carbon monoxide in a real-time manner, giving out warning when the concentration of ambient carbon monoxide is excessively high, and automatically releasing ozone for neutralizing ambient carbon monoxide. The released ozone, after oxidization and disinfection, can be reduced to oxygen, without the problem of residual. Hence, the present invention can secure people from carbon monoxide poisoning.

Ozone is adopted in the present invention for its strong capability of neutralization, decomposition and oxidization. It is capable of decomposing and neutralizing toxic gas. In addition, ozone can be reduced to oxygen after oxidization and disinfection, and thus is free from the problem of residual and any carcinogenic side product.

The present invention has been described with reference to the preferred embodiments and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. An active CO neutralizing device, comprising:
a CO sensing unit for detecting a concentration of ambient carbon monoxide and outputting a warning signal when the concentration is greater than a threshold;
a control unit electrically connected to the CO sensing unit for receiving the warning signal and outputting a trigger signal and a release signal in response to the warning signal;
an alarm unit for receiving the trigger signal and giving out acoustic and visual warning messages; and
an ozone releasing unit for receiving the release signal and releasing the ozone.

2. The active CO neutralizing device of claim 1, wherein the ozone releasing unit further comprises an ozone generator for generating ozone.

3. The active CO neutralizing device of claim 2, wherein the ozone generator is a ceramic ozone generator.

4. The active CO neutralizing device of claim 1, wherein the CO sensing unit further comprises a microcomputer device for comparing the detected concentration of carbon monoxide with the threshold so as to determine whether to give out the warning signal.

5. The active CO neutralizing device of claim 1, wherein the CO sensing unit further comprises a display sub-unit for displaying the concentration of carbon monoxide detected by the CO sensing unit.

6. The active CO neutralizing device of claim 1, wherein the alarm unit further comprises a buzzer for giving out the acoustic warning messages.

7. The active CO neutralizing device of claim 1, wherein the alarm unit further comprises a warning light for giving out the visual warning messages.
